(19) United States
(12) Patent Application Publication
(10) Pub. No.: US 2009/0164893 A1
(43) Pub. Date: Jun. 25, 2009

(54) Method And System For Displaying Article

(75) Inventor: Zaiming Huang, Shenzhen (CN)

Correspondence Address: HARNESS, DICKEY & PIERCE, P.L.C., P.O. BOX 828, BLOOMFIELD HILLS, MI, 48303, US

(73) Assignee: TENCENT TECHNOLOGY (SHENZHEN) COMPANY LIMITED, Shenzhen (CN)

(21) Appl. No.: 12/394,916

(22) Filed: Feb. 27, 2009

Related U.S. Application Data
(63) Continuation of application No. PCT/CN2007/070532, filed on Aug. 21, 2007.

(30) Foreign Application Priority Data
Aug. 28, 2006 (CN) 200610111944.1

(51) Int. Cl. G06F 3/00

(52) U.S. Cl. 715/273

(57) ABSTRACT

The embodiments of the present invention disclose a system for displaying an article, including: an action analyzing module, adapted to obtain action information of a user corresponding to user information, obtain article property information according to the action information; an article matching module, adapted to obtain articles related to the article property information according to the article property information; and a display system interface module, adapted to display the articles obtained by the article matching module. The embodiments of the present invention also disclose a method for displaying an article. According to the embodiments of the present invention, customized article display is provided for the user. Moreover, since the search of the user is avoided, the resources of the article sale system are saved.

### CROSS-REFERENCE TO RELATED APPLICATIONS

This application is a continuation of International Application No. PCT/CN2007/070532 filed on Aug. 21, 2007. This application claims the benefit and priority of Chinese Patent Application No. 200610111944.1, filed Aug. 28, 2006. The entire disclosure of each of the above applications is incorporated herein by reference.

### FIELD

The present disclosure relates to article display technologies, more particularly, to a method and a system for displaying an article.

### BACKGROUND

This section provides background information related to the present disclosure which is not necessarily prior art.

Along with the development of Internet, people can engage various actions on Internet, such as join in a network game on a network game platform, buy an article on Internet, etc. A conventional article sale system displays articles for sale on a webpage, and the display of the articles for sale is always changeless. That is, the article sale system obtains kind and price information of existed articles for sale, and displays the articles to users in a preset changeless sequence. Thus the sequence of the articles for sale seen by different users in different time through clients is always changeless.

However, the demands of different users for buying articles in the article sale system are different. In the prior, it is incapable of providing different article displays according to the demands of the different users and is in capable of providing customized article displays for the users, and thus the user has to search the displayed articles again and again for the needed article, which wastes the time of the user, reduces the efficiency and wastes the resources of the article sale system.

### SUMMARY

This section provides a general summary of the disclosure, and is not a comprehensive disclosure of its full scope or all of its features.

Embodiments of the present invention provide a method and a system for displaying an article, as so to provide a customized article display for users.

The embodiments of the present invention provide a system for displaying an article, including:

an action analyzing module, adapted to obtain action information of a user corresponding to user information, obtain article property information according to the action information;

an article matching module, adapted to obtain articles related to the article property information according to the article property information; and

a display system interface module, adapted to display the articles obtained by the article matching module.

The embodiments of the present invention also provide a method for displaying an article, including:

obtaining action information of a user corresponding to user information according to the user information;

obtaining article property information according to the action information;

obtaining articles related to the article property information according to the article property information; and

displaying the articles.

According to the above solutions, in the embodiments of the present invention, the action information is obtained according to the user information, the article property information is obtained according to the action information, the articles related to the article property information are obtained according to the article property information, and then the articles are displayed. In this way, articles corresponding to the user information are displayed to the user, and thus customized article display is provided to the user. Compared with the conventional technologies, by the implementation of the present invention, the user does not need to search numerous displayed articles again and again, but can directly see the needed article, which saves the time of the user and increases the efficiency of the article sale system. Moreover, since the search of the user is avoided, it is unnecessary to occupy the resources of the article sale system, thereby saving the resources of the article sale system.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a schematic diagram illustrating the structure of a system for displaying an article in accordance with an embodiment of the present invention.

FIG. 2 is a flowchart illustrating a method for displaying an article in accordance with an embodiment of the present invention.

FIG. 3 is a flowchart illustrating a method for displaying an article in accordance with another embodiment of the present invention.

Corresponding reference numerals indicate corresponding parts throughout the several views of the drawings.

### DETAILED DESCRIPTION

Example embodiments will now be described more fully with reference to the accompanying drawings.

Reference throughout this specification to “one embodiment,” “an embodiment,” “specific embodiment,” or the like in the singular or plural means that one or more particular features, structures, or characteristics described in connection with an embodiment is included in at least one embodiment of the present disclosure. Thus, the appearances of the phrases “in one embodiment” or “in an embodiment,” “in a specific embodiment,” or the like in the singular or plural in various places throughout this specification are not necessarily all referring to the same embodiment. Furthermore, the particular features, structures, or characteristics may be combined in any suitable manner in one or more embodiments.

The present invention is further described hereafter in detail with reference to the embodiments to make the object, technical solution and beneficial effects of the present invention more apparent.

In the embodiments of the present invention, article property information is obtained according to prior action information of a user, and then articles related to the article property information are displayed to the user, thereby the customized article display is provided for the user.

The action information in the embodiments of the present invention mainly includes the information of the user engaging various actions on Internet, such as the information of the user joining in a certain network game, the information of the user buying a certain article on Internet, etc. The article property information mainly includes the information related to the article, such as the network game related to the article, other articles related to the article, etc. Specifically, when the user joins in a network game A and a prop X is used in the network game A, the property information of the article X is the network game A, the action information of the user is the information of the user joining in the network game A; and thus, in the embodiment of the present invention, the prop X used in the network game A may be displayed to the user according to the information of the user joining in the network game A. When the user buys an article Y, and the article Y and an article Z are used in set, the property information of the article Z is the article Y, the action information of the user is the information of the user buying the article Y; and thus, in the embodiment of the present invention, the article Z which is used in set with the article Y may be displayed to the user according to the information of the user having bought the article Y.

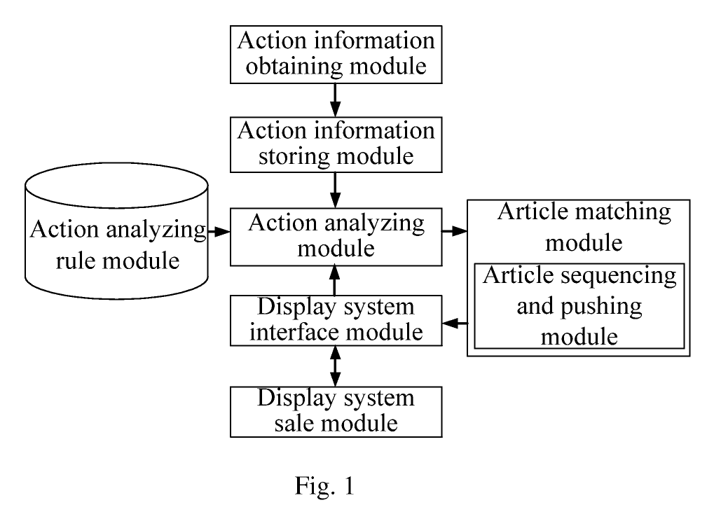

FIG. 1 is a schematic diagram illustrating the structure of a system for displaying an article in accordance with an embodiment of the present invention. Referring to FIG. 1, the system mainly includes a display system interface module, an action analyzing module, an article matching module. The system may further include an action information storing module, an action analyzing rule module, an action information obtaining module and a display system sale module.

The action analyzing module obtains action information according to user information, obtains article property information according to the action information, and sends the article property information to the article matching module.

The article matching module obtains articles related to the article property information according to the article property information, and provides the articles to the display system interface module. As shown in FIG. 1, the article matching module of the embodiment may further include an article sequencing and pushing module. The article sequencing and pushing module determines the sequence of the articles obtained by the article matching module, e.g. the article matched with more article property information is sequenced before the article matched with less article property information, and provides the articles with the determined sequence to the display system interface module.

The display system interface module is mainly adapted to display the articles provided by the article matching module. Here, the displaying usually includes displaying the article, the description of the article, price, etc. to the user through a webpage or other modes. In addition, the display system interface module may further adapted to receive user information of the user, such as user ID and personal information, after the user inputs the user information and logs on the article display system, and send the user information to the action analyzing module.

As shown in FIG. 1, the article display system may further include the action information storing module. The action information storing module stores action information corresponding to the user information. The action information may be the information of the user joining in a certain network game, the information of the user buying a certain article, etc. The action information storing module can store the action information which is obtained by the action analyzing module according to the user information. The action information storing module may be a separate module or may be one part of the action analyzing module.

The article display system may further include the action analyzing rule module. The action analyzing rule module is adapted to store a relationship between the action information and the article property information, such as the relationship between the action information of the user joining in a certain network game and the network game, the relationship between the action information of the user buying a certain article and the bought article, etc. These relationships may be stored as a table, such as stored as an action analyzing rule table, and may also be stored in other modes. The action analyzing rule module may be a separate module or may be one part of the action analyzing module.

As shown in FIG. 1, the article display system may further include the action information obtaining module. The action information obtaining module extracts the user information and the action information corresponding to the user information during the user action, and stores the user information and the action information in the action information storing module. For example, when the user joins in a certain network game, the action information obtaining module obtains the relationship between the action information of the user joining in the network game and the network game. For another example, when the user buys a certain article, the action information obtaining module obtains the relationship between the action information of the user buying the article and the bought article.

The article display system of the embodiment may further include the display system sale module. When the user selects one or more articles from the displayed articles and determines to buy the selected articles, i.e. when receiving information of the user determining to buy the selected articles, the display system sale module implements the sale process, e.g. deducts expenses from the account of the user, sends the articles to the user in the network system, etc.

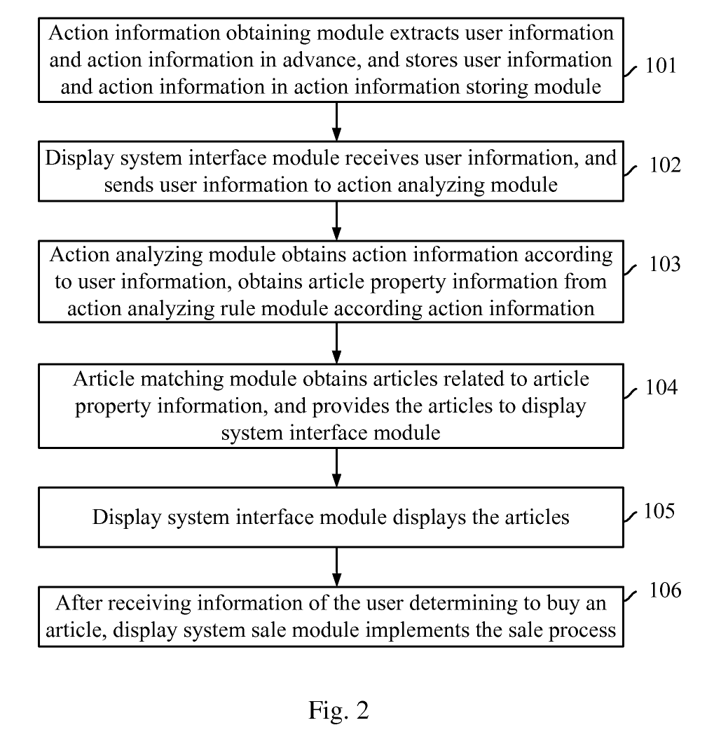

FIG. 2 is a flowchart illustrating a method for displaying an article in accordance with an embodiment of the present invention. Referring to FIG. 2, the method for displaying an article in accordance with an embodiment of the present invention includes the following processes.

Block 101: In a network action process of a user, such as a process of the user joining in a network game or a process of the user buying an article, the action information obtaining module extracts user information and action information corresponding to the user information, such as a relationship between the action information of the user joining in the network game and the network game or a relationship between the action information of the user buying the article and the bought article, and stores the user information and the action information in the action information storing module.

Block 102: The display system interface module receives the user information of the user after the user inputs the user information and logs on the article display system, and sends the user information to the action analyzing module.

Block 103: The action analyzing module obtains the action information from the action information storing module according to the user information sent from the display system interface module, obtains article property information from the action analyzing rule module according the action information, and sends the article property information to the article matching module.

Though the embodiment is described by taking an example that the display system interface module receives the user information and provides the user information to the action analyzing module, the embodiment is not used to limit the present invention, that is, the source of the action information used by the action analyzing module is not limited in the present invention.

Block 104: The article matching module obtains articles related to the article property information, and then provides the articles to the display system interface module.

Before the articles are provided to the display system interface module, the article sequencing and pushing module in the article matching module may further determines the sequence of the articles provided by the article matching module, and provides the articles with the determined sequence to the display system interface module.

Block 105: The display system interface module displays the articles with the determined sequence.

If the sequence of the articles is not determined in block 104, the display system interface module directly display the article without the determined sequence provided by the article matching module.

After the articles are displayed, Block 106 may further be included. In Block 106, after receiving information of the user determining to buy an article, the display system sale module implements the sale process, e.g. deducts expenses from the account of the user, sends the article to the user in the network system, etc.

An article display system in a network game platform is taken as an example to further describe the implement of the present invention. The article display system in the network game platform is the same as the system shown in FIG. 1, but the data and information in the two systems are different. For example, the article display system in the network game platform mainly displays articles used in a network game, such as props, equipment, etc., the action information mainly includes the action information of the user joining in the network game, and the user information usually is the user ID.

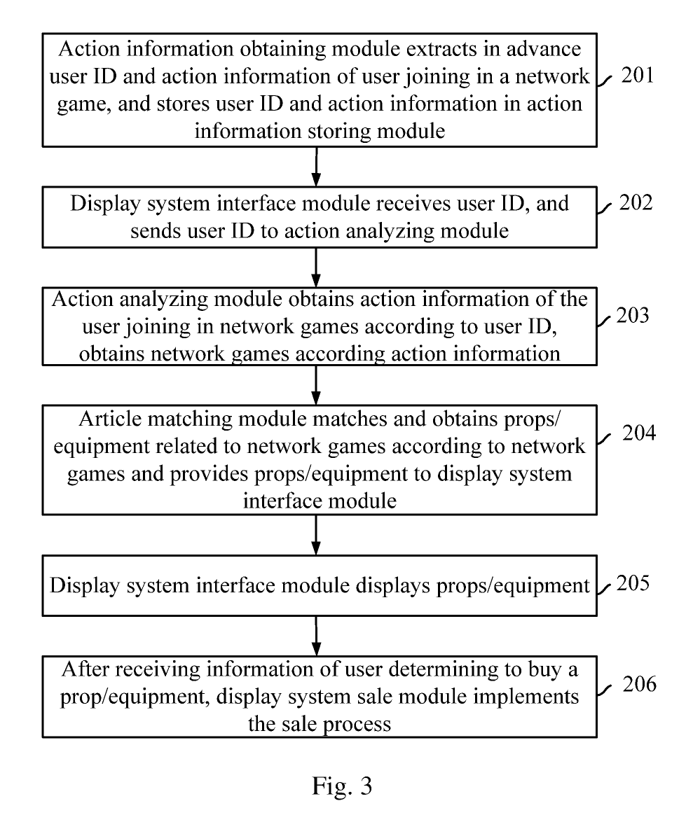

FIG. 3 is a flowchart illustrating a method that an article display system in a network game platform displays articles. Referring to FIG. 3, the method includes the following processes.

Block 201: In a process of a user joining in a network game, the action information obtaining module extracts user ID and action information of the user joining in the network game, and stores the user ID and the action information in the action information storing module. For example, in the process of the user joining in network games A, B, C, D, the action information of the user joining in the network games A, B, C, D is respectively stored in the action information storing module.

Block 202: The display system interface module receives the user ID of the user after the user inputs the user ID and logs on the article display system, and sends the user ID to the action analyzing module.

Block 203: The action analyzing module obtains the action information of the user joining in the network games A, B, C, D from the action information storing module according to the user ID sent from the display system interface module, obtains the network games A, B, C, D from the action analyzing rule module according the action information, and sends the network games A, B, C, D to the article matching module.

Block 204: The article matching module obtains props/equipment related to the network games A, B, C, D according to the network games A, B, C, D, and provides the props/equipment to the display system interface module. For example, the article matching module obtains props/equipment X, Y related to the network game A, obtains props/equipment X, Z related to the network game B, obtains prop/equipment Z related to the network game C, and obtains prop/equipment X related to the network game D, and sends the props/equipment X, Y, Z to the display system interface module.

Before the props/equipment is provided to the display system interface module, the article sequencing and pushing module in the article matching module may further determines the sequence of the props/equipment provided by the article matching module, e.g. the prop/equipment X matched with three network games is sequenced before the prop/equipment Y matched with two network games and the prop/equipment Y matched with two network games is sequenced before the prop/equipment Z matched with one network game, and then provide the props/equipment X, Y, Z with the determined sequence to the display system interface module.

Block 205: The display system interface module displays the props/equipment X, Y, Z with the determined sequence.

If the sequence of the props/equipment is not determined in Block 204, the display system interface module directly display the props/equipment without the determined sequence provided by the article matching module.

After the props/equipment is displayed, Block 206 may be further included. In Block 206, after receiving information of the user determining to buy a prop/equipment, the display system sale module implements the sale process of the prop/equipment, e.g. deducts expenses from the account of the user, sends the prop/equipment to the user in the network system, etc.

As can be seen from the embodiments of the present invention, the action information is obtained according to the user information, the article property information is obtained according to the action information, the articles related to the article property information are obtained according to the article property information, and the articles are displayed. Therefore, articles corresponding to the actions of the user are displayed to the user, and thus customized article display is provided to the user. In this way, the user does not need to search numerous displayed articles again and again, but can directly see the needed article, which saves the time of the user, increases the efficiency of the article sale system. Moreover, since the search of the user is avoided, it is unnecessary to occupy resources of the article sale system, thereby saving the resources of the article sale system.

The foregoing are only preferred embodiments of the present invention and are not for use in limiting the protection scope of the present invention. Any modification, equivalent replacement and improvement made within the scope of the present invention should be covered under the protection scope of the present invention.

The foregoing description of the embodiments has been provided for purposes of illustration and description. It is not intended to be exhaustive or to limit the invention. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the invention, and all such modifications are intended to be included within the scope of the invention.

What is claimed is:

1. A system for displaying an article, comprising:
an action analyzing module, adapted to obtain action information of a user corresponding to user information, obtain article property information according to the action information;
an article matching module, adapted to obtain articles related to the article property information according to the article property information; and
a display system interface module, adapted to display the articles obtained by the article matching module.

2. The system of claim 1, further comprising:
an action information storing module, adapted to store the action information corresponding to the user information for the action analyzing module.

3. The system of claim 2, further comprising:
an action information obtaining module, adapted to extract the user information and the action information during a user action period, store the user information and the action information in the action information storing module.

4. The system of claim 1, wherein the article matching module further comprises:
an article sequencing and pushing module, adapted to determine a sequence of the articles obtained by the article matching module.

5. The system of claim 1, further comprising:
an action analyzing rule module, adapted to store a relationship between the action information of the user and the article property information.

6. The system of claim 1, wherein the action information comprises information of the user engaging an action in a network; the article property information comprises information related to the articles.

7. A method for displaying an article, comprising:
obtaining action information of a user corresponding to user information according to the user information;
obtaining article property information according to the action information;
obtaining articles related to the article property information according to the article property information; and
displaying the articles.

8. The method of claim 7, further comprising:
extracting the user information and the action information corresponding to the user information during a user action period; and storing the user information and the action information.

9. The method of claim 7, further comprising:
determining a sequence of the articles before displaying the articles.

10. The method of claim 7, further comprising:
receiving the user information before obtaining the action information according to the user information.

11. The method of claim 7, wherein the action information comprises information of the user engaging an action in a network; the article property information comprises information related to the articles.

12. The method of claim 7, wherein the action information comprises information of the user buying an article; the article property information comprises the bought article; and the displayed articles comprise articles related to the bought article.

13. The method of claim 7, wherein the action information comprises information of the user joining in a network game; the article property information comprises the network game; and the displayed articles comprise articles related to the network game.

14. The method of claim 13, wherein the articles related to the network game comprise a prop/equipment used in the network game.
